(19) United States
(12) Patent Application Publication
(10) Pub. No.: US 2003/0170531 A1
(43) Pub. Date: Sep. 11, 2003

(54) Electrolyte leakage shield for a battery-powered device

(76) Inventors: Heather N. Bean, Fort Collins, CO (US); Mark N. Robins, Greeley, CO (US); Matt Flach, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/095,814

(22) Filed: Mar. 11, 2002

(51) Int. Cl. H01M 2/10

(52) U.S. Cl. 429/65; 429/100; 429/123

(57) ABSTRACT

A battery shield and method protect a battery-powered device from contamination and potentially deleterious effects of electrolyte leakage from a battery employed by the device. The battery shield comprises a nonconductive body and a plurality of conductive portions that are electrically isolated from one another by the nonconductive body. The nonconductive body encloses at least terminals of the battery. A conductive portion makes electrical contact with each terminal of the battery. An electronic device comprises a removable battery shield. The method comprises inserting a battery into a battery shield that physically separates at least the terminals of the battery from electrical contacts of the device while providing electrical connectivity. The battery shield is one or both of disposable or reusable. A reusable battery shield is cleanable, such that leaked electrolyte is removed before reuse.

### TECHNICAL FIELD

This invention relates to battery-powered devices. In particular, the invention relates to protection of battery-powered devices from leaking battery electrolyte.

### BACKGROUND ART

Batteries used in battery-powered devices are known to leak electrolyte on occasion. Batteries can leak electrolyte when over-discharged, shorted or subjected to high temperatures. In addition, old batteries and those that are defective have been known to exhibit electrolyte leakage. Modem electronic devices can exacerbate the potential for electrolyte leakage due to a common use of stand-by modes in such devices. In stand-by mode, the electronic device continues to draw small amounts of current from the battery. Stand-by modes are often employed in place of an ‘OFF’ state in modem devices to enable the use of momentary contact keys for affecting power ‘ON/OFF’ transitions.

Most batteries employ a relatively caustic or corrosive, semi-liquid to liquid electrolyte. For example, the well-known alkaline battery uses potassium hydroxide (KOH) as an electrolyte. The exposure of the battery-powered device to such a caustic, corrosive material can be very detrimental. Electrolyte leakage and the subsequent exposure to the electrolyte can corrode electrical contacts in the device. In addition, exposure to leaked electrolyte may cause mechanical parts to become brittle and more prone to breakage. In a best case, electrolyte leakage generally makes a mess inside the device. In a worst case, devices that are exposed to leaking electrolyte from a battery are often damaged and, in some cases, rendered useless or permanently disabled. Thus, a leaking battery can, and often does, result in the effective loss of an expensive battery-powered device, such as a digital camera or a personal digital assistant (PDA), for example.

Thus, it would be advantageous to have a way of protecting or shielding a battery-powered device from the effects of electrolyte leakage. Shielding the battery-powered device from electrolyte leakage would solve a long-standing need in the area of battery-powered devices.

### SUMMARY OF THE INVENTION

A battery shield protects a battery-powered device from contamination and potentially deleterious effects of electrolyte leakage from a battery employed by the device. The battery shield is placed between the battery and the device. In particular, the battery shield isolates the battery from battery contacts or terminals of the device.

The battery shield so positioned acts to prevent any leaking battery electrolyte from contacting and damaging the battery-powered device. In some embodiments, the battery shield further contains any leaking electrolyte thus ensuring that the electrolyte cannot contact the device or its constituent elements.

The battery shield comprises a non-conductive portion and a plurality of conductive portions. The conductive portions are electrically isolated from one another by the non-conductive portion and a conductive portion serves as an electrical conduction path for current flowing between the battery and the battery-powered device. In some embodiments, the battery shield is a battery cover and comprises a flexible membrane. The battery cover is placed around a battery prior to installing the battery in the device. In other embodiments, the battery shield is a shield tray comprising a rigid or flexible apparatus that is inserted into a battery compartment of device. The battery is placed in the tray. In yet other embodiments, the battery shield is a separable or removable compartment that isolates the batteries from the device.

In another aspect of the present invention, an electronic device with a removable battery shield is provided. The electronic device receives at least some of its power from a battery. The electronic device comprises contacts or terminals that electrically interface with terminals of the battery shield. The electronic device of the present invention incorporates any of the above embodiments of the battery shield of the present invention, depending on the embodiment.

In yet another aspect of the present invention, a method of protecting a battery-powered device from leaking battery electrolyte is provided. The method comprises inserting a battery into a battery shield and installing the shield into the battery-powered device. The battery shield may be either reusable or disposable. Upon an occurrence of a leak of electrolyte from the battery, the method may further comprise removing the battery shield and battery from the battery-powered device. If the battery shield is a reusable battery shield, the method further comprises washing the battery shield to remove leaked electrolyte in preparation for reuse. If the battery shield is a disposable battery shield, the method further comprises discarding the battery and the battery shield in a suitable manner. In some cases, a reusable battery shield may be discarded if the situation warrants.

Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a battery shield of the present invention as a battery cover adapted for use with a cylindrical battery.

FIG. 2A illustrates a preferred embodiment of the battery cover illustrated in FIG. 1 comprising a lower portion and an upper portion.

FIG. 2B illustrates a battery inserted in the lower portion of the battery cover.

FIG. 2C illustrates the upper portion of the battery cover having been slipped over the battery and lower portion illustrated in FIG. 2B.

FIG. 3 illustrates an embodiment of the shield tray embodiment of the battery shield according to the present invention, the shield tray being adapted for and illustrated holding a pair of batteries by way of example.

FIG. 4 illustrates a cross section through the shield tray illustrated in FIG. 3, the shield tray being inserted in a battery-powered device.

FIG. 5A illustrates an example of a combination of a battery compartment embodiment of the battery shield of the present invention and a battery-powered device in the form of a digital camera depicting the battery compartment connected to the camera.

FIG. 5B illustrates an example of a combination of a battery compartment embodiment of the battery shield of the present invention and a battery-powered device in the form of a digital camera depicting the battery compartment separated from the camera.

FIG. 6 illustrates a cross section through the battery compartment illustrated in FIGS. 5A and 5B.

FIG. 7 illustrates a flow chart of a method of protecting a battery-powered device from leaking battery electrolyte according to the present invention.

### MODES FOR CARRYING OUT THE INVENTION

The present invention provides a battery shield for a battery-powered device. According to the present invention, the battery shield protects or shields a device from the contamination and potentially deleterious effects of electrolyte leakage from a battery employed by the device. In particular, the present invention provides a battery shield apparatus and method that by the use of the shield in conjunction with the device helps to resist the corrosive affects of electrolyte that can leak from the battery. In particular, the battery shield acts as an electrolyte barrier. Furthermore, the battery shield acts to contain and control the spread of leaking electrolyte and isolates the device from the leaking electrolyte. The leaking electrolyte, thus held in check by the present invention, is prevented from damaging or otherwise adversely affecting the battery-powered device.

According to the present invention, the battery shield is a user removable and/or separable apparatus that is placed between the battery and battery terminals or contacts of the device. The battery shield isolates the battery from the device and battery terminals thereof. In various embodiments, the battery shield of the present invention is disposable and/or reusable, such as being washable, thereby facilitating straightforward recovery from a battery leakage event or situation that may occur. Instead of dealing with a possibly difficult cleaning of a device battery compartment or even permanent damage of the battery-powered device due to battery leakage, a user of the device need only clean or replace the battery shield and replace the battery. Essentially, the battery shield affords the device a relatively low cost layer of protection from potentially deleterious and corrosive effects of battery electrolyte leakage. The present invention is especially useful for relatively expensive battery-powered devices, such as a digital or conventional camera, a laptop computer, a CD or MP3 player, a cellular telephone, or a personal digital assistant (PDA). However, the present invention is useful for any device that uses a battery.

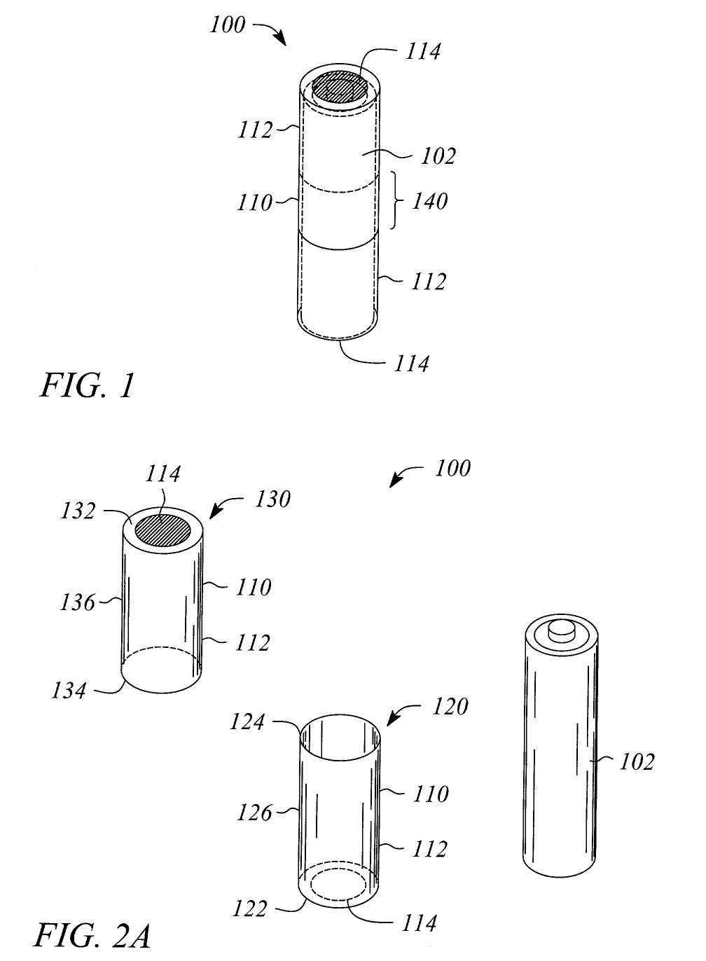

In an embodiment, the battery shield of the present invention comprises a battery sheath or cover 100 that encloses and/or surrounds a battery 102 or a portion of the battery 102. By way of example, FIG. 1 illustrates an embodiment of the battery cover 100 of the present invention adapted to and enclosing a battery 102 having a cylindrical form factor. The battery cover 100 comprises a thin, preferably flexible, membrane 110. The membrane 110 comprises a non-conductive portion 112 and a plurality of conductive portions 114. Each of the conductive portions 114 is electrically isolated from one another by and positioned within the non-conductive portion 112 such that the conductive portions 114 provide a conductive path from an inner surface of the membrane 110 to an outer surface. Furthermore, the conductive portions 114 are positioned such that they are aligned with terminals of the battery 102 when the cover 100 is applied thereto. Thus, when the battery 102 is within the cover 100, the conductive portions 114 serve as electrical contacts for conducting battery current from the battery terminals through the membrane 110 of the battery cover 100.

The battery cover 100 may be adapted to cover a single battery 102 or a plurality of batteries 102 (not shown). Preferably, the battery cover 100 comes in different sizes that are adapted for a variety of different form factors of the battery 102. Typical batteries with cylindrical form factors to which the battery cover may be adapted include, but are not limited to, ‘D’, ‘C’, ‘AA’, and ‘AAA’. The battery cover 100 may be adapted to (or produced to fit) non-cylindrical battery form factors as well, such as button cells, 9V cells and various application specific battery packs. The preferred flexible membrane 110 of the battery cover 100 generally takes the shape (or adapts to the shape) of the particular battery being enclosed by the cover 100. The battery 102 is placed or enclosed within the battery cover 100 prior to being placed into a battery compartment or battery holder of the battery-powered device. Thus, the membrane 110 is preferably thin enough so that the presence of the battery cover 100 does not interfere with or impede battery insertion in the battery-powered device. One of ordinary skill can readily determine a suitable thickness of the membrane 110 for a given application and/or battery-powered device without undue experimentation.

The non-conductive portion 112 of the membrane 110 is preferably made of a non-conductive, flexible, essentially fluid impenetrable material. By ‘fluid impenetrable’ it is meant that the battery electrolyte, which leaks from a battery over time, does not penetrate through the material. In addition, it is preferred that the material be resistant to the corrosive effects of battery electrolyte. Various plastic and related materials are known to provide such characteristics. One acceptable plastic is polyethylene. Other materials such as Mylar® or Kapton® films are also acceptable. Mylar® and Kapton® are registered trademarks of E. I. Du Pont De Nemours and Company Corporation Delaware, 1007 Market Street Wilmington Del. 19898. The conductive portions 114 are preferably made of nickel or nickel-plated foil. Various plating techniques that provided for creating sealed vias through a membrane may also be used to create the conductive portions 114 directly in the material of the non-conductive portion 112 of the membrane 110.

The battery cover 100 may be washable and reusable or disposable. Preferably, the battery cover 100 is disposable. With a disposable battery cover 100, the cover 100 and battery enclosed therein are discarded whenever the battery 102 needs to be discarded. Advantageously, such a disposable battery cover eliminates the need to handle a potentially leaking battery 102. Any electrolyte that may have leaked from the battery 102 is effectively contained within the battery cover 100. Thus, potentially harmful exposure to the electrolyte is minimized for both the battery-powered device and the one responsible for changing the battery 102. Moreover, a new cover 100 is used to enclose a new battery 102. The consumer inserts a new battery into a new battery cover 100 before inserting the new battery 102 into the device. Alternatively, a battery manufacturer or supplier may supply their batteries with the battery cover 100, according to the present invention. Providing a battery that is preassembled with the battery cover 100, according to the invention, saves the consumer time and provides the consumer a convenience. A battery with a preassembled battery cover 100, according to the present invention, can take the form of a shrink wrap plastic having conductive contacts 114.

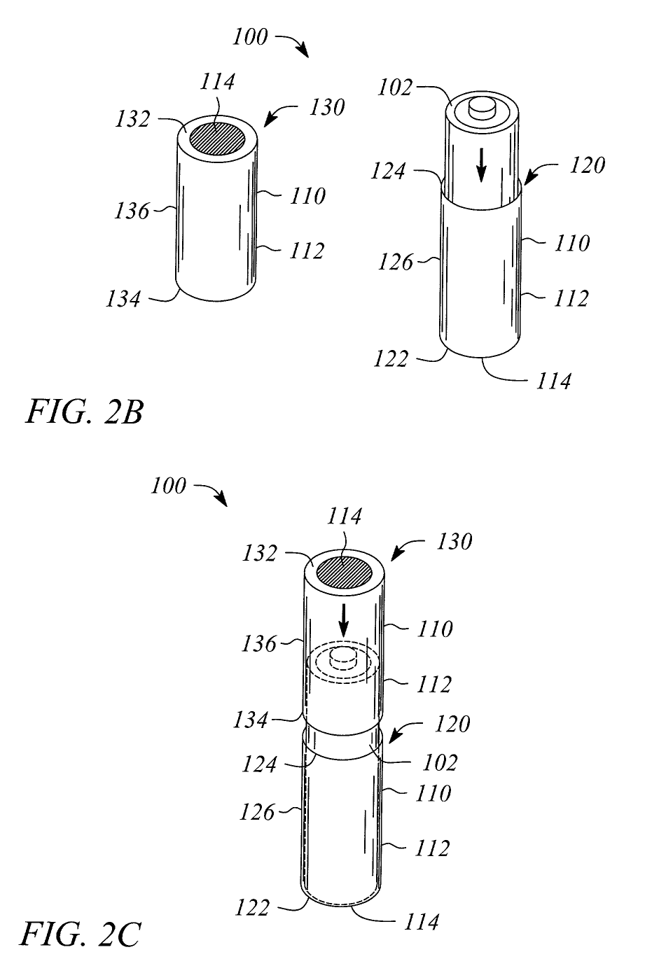

In a preferred embodiment, the battery cover 100 and membrane 110 thereof comprises a first or lower membrane portion 120 and a second or upper membrane portion 130. FIG. 2A illustrates an example of the preferred embodiment of the battery cover 100 adapted for a battery 102 having a cylindrical form factor such as an ‘AA’ battery. The first portion 120 of the example battery cover 100 illustrated in FIG. 2A is a cylindrical sleeve having a closed end 122 and an open end 124. A portion of the closed end 122 is one of the conductive portions 114 of the membrane while a balance of the closed end 122 and a sidewall 126 of the cylindrical sleeve is the non-conductive portion 112. Since a typical cylindrical battery has a first terminal and a second terminal, each terminal being centrally located at opposing ends of the battery 102, the conductive portion 114 is preferably positioned in a center of the closed end 122 so as to align with a first terminal of the battery 102 (e.g., a negative terminal) inserted into the sleeve of the first portion 120.

The second portion 130 is also a cylindrical sleeve having an inside diameter that is preferably larger than an outside diameter of the cylindrical sleeve of the first portion 120. As illustrated in FIG. 2A the second portion 130 is a cylindrical sleeve having a closed end 132 and an open end 134. A portion of the closed end 132 is one of the conductive portions 114 of the membrane 110 while a balance of the closed end 132 and a sidewall 136 of the cylindrical sleeve is the non-conductive portion 112. The conductive portion 114 is positioned in a center of the closed end 132 so as to align with the second terminal of the battery 102 (e.g., a positive terminal) inserted into the second portion 130.

To enclose the battery 102 in the cylindrical battery cover 100, the battery 102 is placed in the first portion 120 as illustrated in FIG. 2B. A thick arrow illustrated in FIG. 2B indicates a direction for placing the battery 102 in the first portion 120. The second portion 130 is then slipped over the battery 102 as illustrated in FIG. 2C. A thick arrow illustrated in FIG. 2C depicts a direction for placing the second portion 130 of the cylindrical battery cover 100 over the battery 102. Either the first portion 120 or the second portion 130 can be slightly larger in diameter relative to the other portion, so that the relatively larger diameter portion slips over the other diameter portion and overlaps therewith.

Referring again to FIG. 1, an overlap 140 of the first and second portions 120, 130 assists in retaining within the battery cover 100 any electrolyte leaking from the battery 102. In many cases the overlap 140 is sufficient to protect the battery-powered device from the leaking electrolyte. In other cases, a seal between the first and second portions 120, 130 is desirable. Thus, in some embodiments of the battery cover 100 the first and second portions 120, 130 may be sealed or bonded to one another after insertion of the battery 102. Any sealing or bonding method compatible with the membrane material may be used to provide such a seal. For example, an adhesive may be applied to the overlap 140 to affect such a seal. Similarly, heat sealing may be employed to produce the seal. Depending on the embodiment, the seal may be breakable for the purposes of reusing the cover 100.

In other embodiments of the battery cover 100 comprising a first portion 120 and a second portion 130, the portions 120, 130 do no overlap (not illustrated). For example, the first and second portions 120, 130 may be relatively short cylindrical sleeves that slip over the terminal ends of the battery 102. In such an embodiment, the cover 100 does not contain any leaking electrolyte, but simply shields the electrical contacts of the battery-powered device from any leakage. In yet another embodiment of the battery cover 100, the first and second portions 120, 130 are simply membrane disks, similar to just the closed ends 122 and 132 of the portions 120, 130, that are placed between each terminal of the battery 102 and the respective electrical contacts of the battery-powered device. Each embodiment of the cover 100 described above can be provided as a user applied cover 100 or manufacturer applied cover 100, in accordance with the present invention.

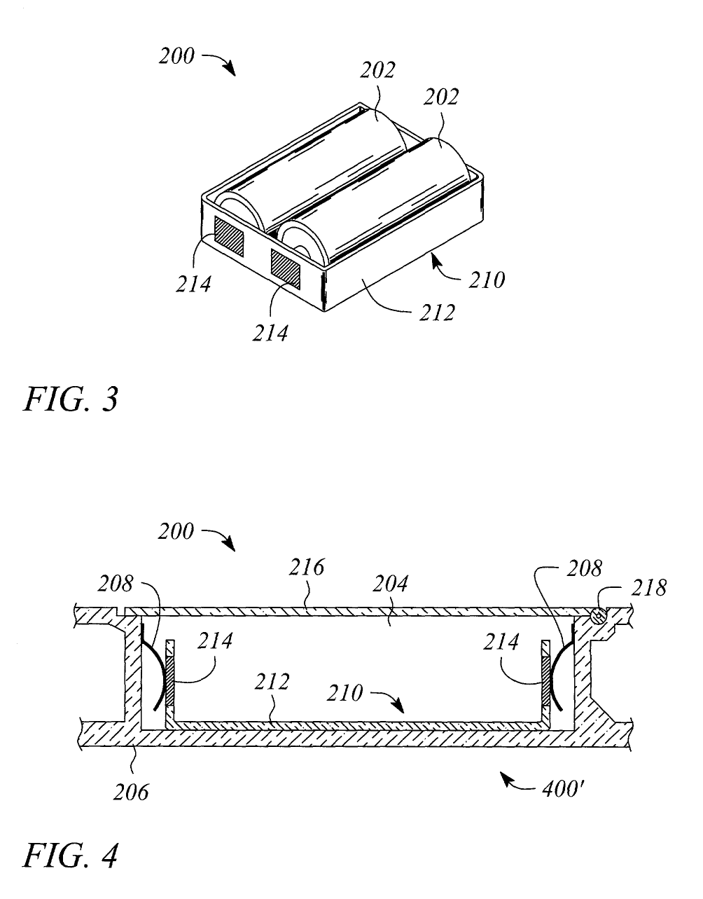

In another embodiment, the battery shield of the present invention comprises a user-insertable shield tray 200. FIG. 3 illustrates an embodiment of the shield tray 200 adapted for holding and shielding a pair of cylindrical batteries 202. FIG. 4 illustrates a cross section through the shield tray 200 inserted in a compartment 204 of a battery-powered device 206 with the batteries 202 removed for clarity. The shield tray 200 is preferably placed into a battery compartment 204 of the battery-powered device 206 prior to insertion of the battery 202. By inserting the tray 200 prior to battery insertion, mechanical and structural constraints and characteristics of the tray 200 are somewhat relaxed since the tray 200 need not be capable of supporting the batteries 202 outside of the compartment 204. However, it is entirely within the scope of the present invention for the tray 200 to be capable of accepting batteries 202 prior to the tray 200 being inserted in the compartment 204.

The shield tray 200 comprises a shell 210. The shell 210 may comprises a flexible, moldable material or a molded rigid material. The shield tray 200 comprising a flexible, moldable shell 210 molds or conforms to an interior shape of the battery compartment 204 when it is inserted. The shield tray 200 comprising a rigid shell 210 has a shape that is pre-molded to conform to the interior shape of the battery compartment 204. The shield tray 200 may or may not have a lid (not illustrated) in addition to the shell 210.

Whether flexible or rigid, the shell 210 comprises a non-conductive portion 212 and a plurality of conductive portions 214. The conductive portions 214 preferably are located within the shell 210 such that they align with electrical terminals or contacts 208 of the battery compartment 204. When inserted in the compartment 204, the conductive portions 214 of the shell 210 serve to conduct battery current from a battery inserted in the shield tray 200 to electrical contacts 208 of the compartment 204. Moreover, the shield tray 200 contains any electrolyte that may leak from the battery 202, thus protecting the contacts 208 from damage due to the corrosive effects of the electrolyte.

The shell 210 may be made of any of a number of flexible or moldable materials including, but not limited to, Kapton®, Mylar®, polyethylene, and various thermoset or injection molded plastics. The moldable materials can be molded into a shape of the battery compartment 204 by various injection, compression, transfer, or other molding techniques known in the art. As with the battery cover 100 of the present invention, the shield tray 200 preferably employs nickel foil or a nickel-plated foil as the conductive portions 214. However, any suitable conductive material that can be integrated into or inserted in the shell 210 may be employed. One of ordinary skill can readily identify numerous suitable approaches to providing such conductive portions 214 within the shell 210 of the shield tray 200.

The shield tray 200 may be washable and reusable. When a battery leakage event occurs, the washable shield tray 200 is simply removed from the battery compartment 204 and washed to remove any residual electrolyte. Once cleaned, the shield tray 200 is reinserted into the battery compartment 204 and the device 206 is ready to accept a new battery 202. Alternatively, the shield tray 200 may be disposable. If a battery leakage event occurs, the disposable shield tray 200 is discarded and a new tray 200 is inserted in the battery compartment 204 to ready the battery-powered device 206 for a new battery 202.

FIG. 4 illustrates an embodiment of the device 206, wherein the compartment 204 has a lid 216 operable by a hinge 218 for accessing the compartment 204 by way of example and not limitation. Other accessible compartments are readily apparent to one skilled in the art and all such accessible compartments are within the scope of the present invention. According to the invention, the shield tray 200 is not a device manufacturer-installed tray or battery manufacturer/supplier-installed tray. Advantageously and conveniently, the consumer or user of the device may install and remove the shield tray 200 from the device compartment 204, according to the present invention. Further advantageously, the consumer or device user may clean or dispose of the shield tray 200 and load the cleaned shield tray 200 or a new shield tray 200 with a new battery. The present invention is particularly useful when using off-the-shelf or commercially available batteries, such as the alkaline battery chemistry type, which is a popular battery chemistry of consumers.

In yet another embodiment, the battery shield of the present invention comprises a removable or separable battery compartment 300 that holds a user-replaceable battery and is adapted for use with a battery-powered device 304. The battery compartment 300 takes the place of a conventional battery compartment or holder that is integral to the conventional device. The battery compartment 300 isolates the battery from the battery-powered device 304, thus preventing electrolyte leakage from damaging the battery-powered device 304. The battery compartment 300 may be either disposable or washable and reusable. In a preferred embodiment, the battery compartment 300 is adapted to hold user-replaceable conventional form factor batteries, such as commercially available alkaline batteries including, but not limited to having an ‘AA’ form factor, for example.

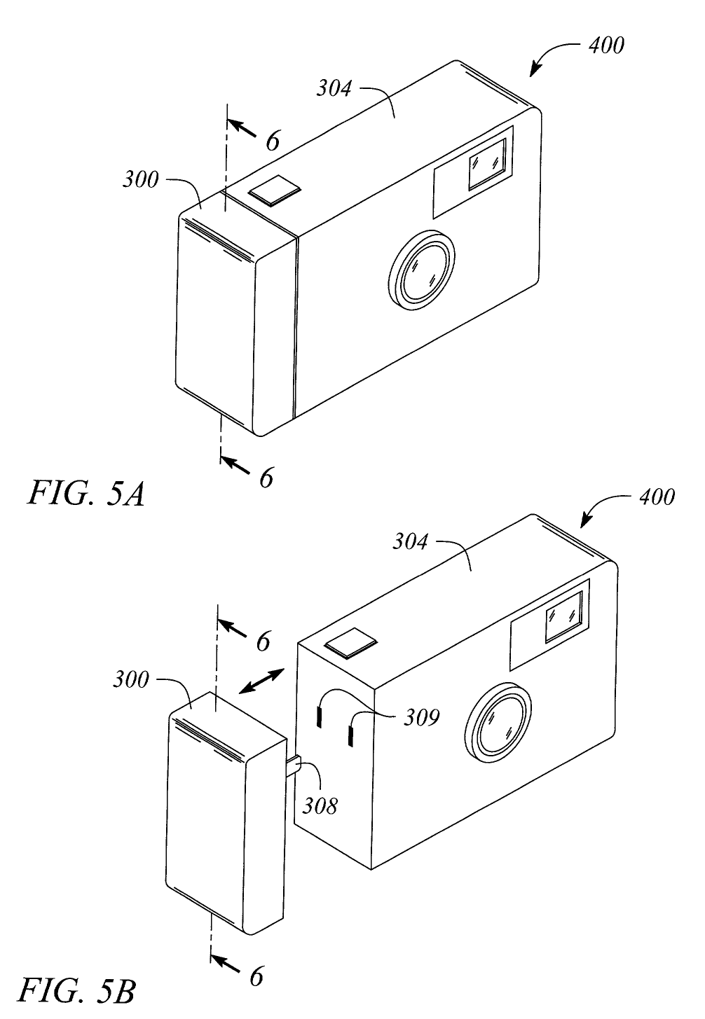

FIGS. 5A and 5B illustrate an example of an embodiment of the battery compartment 300 and an example embodiment of a battery-powered device 304. The battery-powered device 304 is depicted as a digital camera for illustrative purposes and is not intended to limit the scope of the present invention. FIG. 5A illustrates the battery compartment 300 of the present invention attached or connected to the device 304. FIG. 5B illustrates the battery compartment 300 separated from the battery-powered device 304. A thick, double-headed arrow in FIG. 5B indicates the separable/insertable directions and replaceable nature of the battery compartment 300 of the present invention.

The battery compartment 300 is adapted to connect to the battery-powered device 304 both electrically and mechanically. As illustrated in FIG. 5B, insertable contacts or pins 308 provide the electrical connection between the battery compartment 300 and the device 304. When the battery compartment 300 is connected to the device 304, the pins 308 slip into receptacles or sockets 309 on the device 304 thus allowing electrical current to flow from the batteries in the battery compartment 300 to the device 304. The battery compartment 300 electrical connection to the battery-powered device may employ any of a number of well-known electrical connection approaches including, but not limited to, electrical spring contacts, male/female plug and socket arrangements, or a short, detachable wire harness. In other embodiments (not illustrated) contact plates are utilized. In these embodiments, the electrical connection preferably employs some form of spring contact to minimize intermittent electrical contact due to vibration.

Mechanical connection of the battery compartment 300 to the battery-powered device 304 employs a suitable mechanical fastener. One of ordinary skill in the art is familiar with such electrical and mechanical connections. Preferably a mechanical retainer (not illustrated), such as a spring latch or catch, is employed to provide a positive mechanical connection between the battery compartment 300 and the battery-powered device 304. The intent of the mechanical retainer is to insure that the battery compartment 300 and the device 304 remain connected unless and until the user desires otherwise. In other cases, a mechanical retainer that is separate from the electrical connection is not used and the electrical connection further provides a mechanical connection. For example, friction between the pins 308 and the receptacles 309 can maintain the necessary mechanical connection for the purposes of the present invention. The configuration of the electrical and mechanical connection of the battery compartment 300 to the device 304 is dependent on the design of the battery-powered device 304 and its respective application and use. One skilled in the art can readily devise additional combinations of, and approaches to providing, electrical and mechanical connection between the separable battery compartment 300 and a battery-powered device 304, according to the present invention. All such connections and combinations are within the scope of the present invention.

In yet other embodiments, a battery compartment 300′ (not illustrated) may be inserted into a compartment within the battery-powered device 304 in a manner analogous to a conventional battery pack. In such an embodiment, the battery-powered device 304 would have a compartment that was adapted for receiving the insertable battery compartment 300′. The difference between a conventional battery pack and the insertable battery compartment 300′ of the present invention is that the battery compartment 300′ not only holds the batteries but also shields the device 304 from electrolyte that may leak from the batteries being held. Additionally, the insertable battery compartment 300′ accepts user-replaceable batteries unlike conventional insertable battery packs.

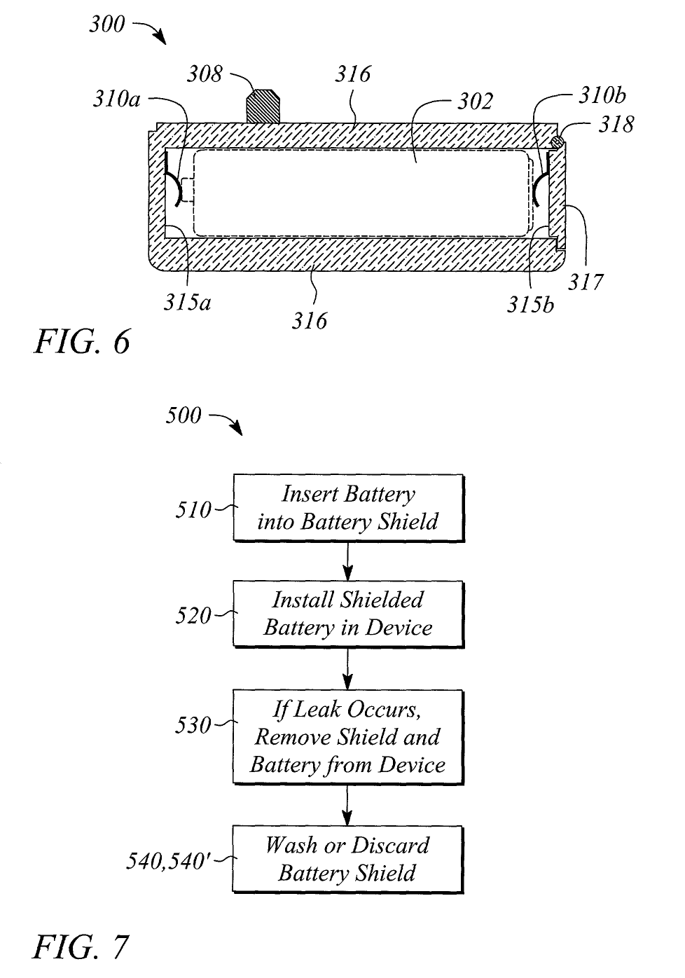

FIG. 6 illustrates a cross section through the battery compartment 300 illustrated in FIGS. 5A and 5B. The battery 302 is illustrated as a dashed line to distinguish it from the compartment 300. The battery compartment 300 illustrated in FIG. 6 is merely one embodiment and is provided solely for the purpose of discussion hereinbelow. Other embodiments of the battery compartment 300 will be readily apparent to those skilled in the art based on the discussion of FIGS. 5A, 5B and 6.

As illustrated in FIG. 6, the battery compartment 300 is an enclosure comprising a first set 310 of interior electrical terminals or contacts 310a, 310b extending inside of the enclosure on opposite wall ends 315a, 315b, and a second set 308 of electrical terminals or pins extending outside of the enclosure on a side wall 316 (only one pin 308 is visible in the view illustrated in FIG. 6). The side wall 316 extends between the opposite ends 315a, 315b and is integrally connected to the ends. One of the ends 315b is adapted to provide access to an interior of the battery compartment 300 for the purpose of inserting and/or removing the battery 302. FIG. 6 illustrates the access as a door 317 mounted on a hinge 318 that also functions as the above-mentioned wall end 315b. Other mechanisms for providing access including, but not limited to a sliding cover, are well-known in the art and may be employed to provide access in accordance with the invention. Additionally, access through a side wall 316, instead of the wall end 315a, 315b, using a hinged or sliding cover is also within the scope of the present invention.

The opening provided by the door 317 is sized to allow the passage of the battery 302 therethrough. The opening is closed off by the door 317 having the hinge mechanism 318 at one end thereof and an open/close mechanism (not illustrated) at an opposite end thereof. When the lid 317 is closed, the battery compartment 300 is preferably fluid-tight or fluid impenetrable. The first set 310 of terminals are electrically connected to the second set 308 of terminals via separate electrically conductive paths or traces (not illustrated). The traces may be on an inside surface of the respective walls 315a, 315b and 316 of the enclosure or embedded into the respective walls of the enclosure. Preferably, the traces are protected by being embedded or covered so that electrolyte leakage from the battery is less likely to damage the traces.

The battery compartment 300, 300′ can be made from an electrically nonconductive and effectively fluid impenetrable enclosure material that is either rigid or flexible. A rigid material, one that forms a rigid enclosure, is generally preferred for embodiments in which the compartment 300, 300′ is attached or appended to the outside of the device 304. Such a rigid material is preferred for its relative durability. Materials useful for the battery compartment 300, 300′ include, but are not limited to, moldable thermoplastic and thermoset materials. The moldable materials can be molded into a battery compartment 300, 300′ of the present invention by various injection, compression, transfer, or other molding techniques known in the art.

By ‘fluid impenetrable’ it is meant that the battery electrolyte, which may leak from a battery over time, does not penetrate through the material or material interfaces such as those along a periphery of the lid 317. Thus, the battery compartment 300, 300′ is preferably fluid impenetrable thereby impeding distribution of electrolyte into or onto portions of the device 304 that may be damaged or adversely affected by such an exposure to battery electrolyte.

By ‘rigid’ it is meant that the material forms a shield tray 200 or battery compartment 300, 300′ that is durable, tough and hard. By ‘flexible’ it is meant that the material conforms to the shape of the battery to form an enclosure that is durable, tough and compliant. Materials that form rigid enclosures for the apparatus of the invention have relatively higher tensile strength and initial modulus than those materials that form flexible enclosures. A rigid material is preferred for the battery compartment 300 described above. However, both rigid and flexible enclosures are useable for the embodiments of the shield tray 200 and the battery compartment 300′ that are designed to fit inside the battery-powered device 304.

As mentioned above, the battery compartment 300, 300′ can be disposable or reusable, depending on economical considerations of its manufacture and frequency of use, and on environmental considerations, to name a few. In either case, the battery compartment 300, 300′ is removable by the user. The user can disconnect the battery compartment 300, 300′ from the device for disposal or reuse. If the battery compartment 300, 300′ is reused, the user simply removes the spent or discharged battery from the battery compartment 300, inserts a new battery, and reconnects the battery compartment 300, 300′ to the device 304. The battery compartment 300, if reused, also can be cleaned to remove any of such leakage from the spent battery. Advantageously, the removable battery compartment 300, 300′ also is a protective storage container for a battery that still has useful working life (is not discharged). In this way, the battery is disconnected from the device 304 when the device 304 is not in use, and stored conveniently in the battery compartment 300, 300′ until needed. The battery compartment 300, 300′ can be provided to a user as an accessory unit for the device 304. Moreover, the battery compartment 300, 300′ may serve as a primary battery power source, sourcing power directly to the battery-powered device 304 or as a secondary battery power source that augments or supplements an primary battery power source of the battery-powered device 304.

In another aspect of the invention, an electronic device 400 having a removable battery shield is provided. The electronic device 400 of the present invention includes, but is not limited to, a digital camera, a personal digital assistant (PDA), or a digital video camera, for example, that obtains some or all of its power from a battery. The electronic device 400 is particularly directed to those consumer electronic devices that would otherwise be damaged by electrolyte leakage from a battery, but for the invention. FIGS. 5A and 5B are illustrative of the electronic device 400 of the present invention. The electronic device 400 comprises contacts or terminals 309 that electrically interface with terminals of the battery shield. In an embodiment of the device 400, the device 400 has an interface, such as the socket 309, to receive the removable battery compartment 300, 300′. In this embodiment, the device 400 optionally further comprises an integral battery compartment. In another embodiment of the device 400′, the device 400′ has an integral battery compartment 206 that is adapted to receive the shield tray 200 of the present invention. In still another embodiment of the device 400″, the device 400″ has an integral battery compartment that is adapted to receive a battery having the battery cover 100 of the present invention. Still further, other embodiments of the device 400, 400′, the battery compartment 300, 300′ and the shield tray 200 may further comprise the battery cover 100 to enclose a battery and still be within the scope of the present invention.

In another aspect of the invention, a method 500 of protecting a battery-powered device from leaking battery electrolyte of a battery employed with the device is provided. FIG. 7 illustrates a flow chart of the method 500. The method 500 comprises inserting 510 a battery into a battery shield. The battery shield is preferably one or more of the battery shields 100, 200, or 300 of the present invention. The battery shield may be either reusable or disposable. Once inserted in the battery shield, the battery is said to be a ‘shielded battery’.

The method 500 further comprises installing 520 the shielded battery in the battery-powered device. Installing 520 may be more appropriately termed “connecting” depending on which embodiment of the shield is employed (e.g. when using the externally connected battery compartment 300). Also as noted hereinabove, in some embodiments of the battery shield, it may be preferable to insert the shield in the battery-powered device prior to inserting the battery in the shield. In such instances, inserting 510 and installing 520 are simply performed in reverse order as installing 520 followed by inserting 510, and are still within the scope of the present invention.

Upon an occurrence of a leak of electrolyte from the battery, the method 500 may further comprise removing 530 the battery shield and battery from the battery-powered device and washing 540 or discarding 540′ the shield, once the battery is removed from the shield. For example, if the battery shield is a reusable battery shield, the method 500 further comprises washing 540 the battery shield to remove leaked electrolyte in preparation for reuse. Alternatively, if the battery shield is a disposable battery shield, the method 500 further comprises discarding 540′ the battery and battery shield in a suitable manner. In some cases, a reusable battery shield may be discarded 540′ if the situation warrants. Discarding 540′ a reusable battery shield is often warranted when the electrolyte has damaged the battery shield or cleaning is impractical or inconvenient for the device user. In either case, once the battery shield is removed 530 from the device, the device is readied to receive another battery shield, regardless of whether the shield is a previously cleaned shield or new battery shield. Advantageously, the method of the present invention protects the device from a leakage event.

Thus, there have been described a battery shield 100, 200, 300, 300′ that protects electrical contacts and other components of a battery-powered device from the detrimental and/or corrosive effects of leaking battery electrolyte. In addition, a battery-powered device 400, 400′, 400″ comprising the battery shield has been described, along with a method 500 of protecting a battery-powered device from leaking battery electrolyte using a battery shield of the present invention. It should be understood that the above-described embodiments are merely illustrative of the some of the many specific embodiments that represent the principles of the present invention. Clearly, those skilled in the art can readily devise numerous other arrangements without departing from the scope of the present invention.

What is claimed is:

1. An apparatus that shields a battery-powered device from electrolyte leakage from a battery comprising:
a nonconductive body portion, the body portion enclosing at least terminals of a battery; and
a plurality of electrically conductive portions, each conductive portion being electrically isolated from others of the plurality by the nonconductive body portion, a conductive portion of the plurality being electrically connected to each terminal of the battery.

2. The apparatus of claim 1, wherein the non-conductive body portion comprises a flexible membrane sheath, the sheath accommodating a battery having any commercially available battery form factor.

3. The apparatus of claim 1, wherein the nonconductive body portion comprises a membrane disk, each disk having at least one conductive portion of the plurality that is surrounded by the nonconductive portion, the conductive portion of each disk extending through the nonconductive membrane disk.

4. The apparatus of claim 3, wherein the disk is sized and shaped to fit within the device with a battery, the disk electrically connecting the battery to the device, such that the disk is a shield between the battery and the device.

5. The apparatus of claim 1, wherein the nonconductive body portion and the conductive portions enclose an entire battery.

6. The apparatus of claim 5, wherein the nonconductive body portion comprises a membrane sheath that takes a shape of a battery.

7. The apparatus of claim 1, wherein the nonconductive body portion comprises a first end and a second end, each end having at least one conductive portion of the plurality, the first end enclosing at least one battery terminal, the second end enclosing at least another battery terminal.

8. The apparatus of claim 7, wherein the first end and the second end are separate membrane enclosures that are installed over at least the battery terminals.

9. The apparatus of claim 8, wherein the nonconductive body portions of the first end and the second end make contact with each other when installed.

10. The apparatus of claim 8, wherein the first end and the second end remain separate from each other when installed.

11. The apparatus of claim 8, wherein the nonconductive body portion of the first end is slightly larger than the nonconductive portion of the second end, such that the nonconductive portion of the first end overlaps the nonconductive portion of the second end when installed.

12. The apparatus of claim 8, wherein the ends are sized and shaped to fit within the device, the ends electrically connecting a battery to the device, such that the ends are shields between the battery and the device.

13. The apparatus of claim 1, wherein the portions are sized and shaped to accommodate installation of a battery into the device, the conductive portions electrically connecting the battery to the device, the nonconductive body portion and the conductive portions being shields between the battery and the device.

14. The apparatus of claim 1, wherein the nonconductive body portion is a tray having a support wall and a plurality of side walls extending from a periphery of the support wall, at least one conductive portion being located in opposite side walls.

15. The apparatus of claim 14, wherein when a battery is installed in the tray, the battery terminals contact the conductive portions in the opposite side walls.

16. The apparatus of claim 14, wherein the tray further has a removable lid, the removable lid contacting the plurality of side walls opposite to the support wall when installed and enclosing an interior of the tray.

17. The apparatus of claim 14, wherein the tray is made from a moldable plastic, the tray accommodating a battery having any commercially available battery form factor.

18. The apparatus of claim 14, wherein the tray is sized and shaped for installation in the device, such that the plurality of conductive portions makes electrical connection with terminals of the device.

19. The apparatus of claim 18, wherein the conductive portions in opposite side walls extend through the respective side walls of the tray, such that when the tray is installed in the device, the extended conductive portions physically contact the terminals of the device.

20. The apparatus of claim 18, wherein the conductive portions in the opposite side walls are separately electrically connected to conductive traces on the tray, such that when the tray is installed in the device, the conductive traces terminate in contacts that physically contact the terminals of the device.

21. The apparatus of claim 14, wherein the tray is molded into a size and a shape that fits within the device, the tray electrically connecting a battery to the device, such that the tray is a shield between the battery and the device.

22. The apparatus of claim 1, wherein the nonconductive body portion is a compartment that fully encloses a battery and provides electrical connection between the battery and the device, the compartment being removably attached to an exterior of the device, the compartment having a lid to provide access to an interior of the compartment where a battery is inserted and removed.

23. The apparatus of claim 22, wherein at least one conductive portion of the plurality extends through a wall of the compartment to electrically connect with an externally accessible electrical contact on the device for receiving battery power, the at least one conductive portion providing the compartment removable attachment to the device, such that the battery power is disconnected when the compartment is removed from the device.

24. The apparatus of claim 23, wherein the compartment further has a mechanical fastener to further removably attach the compartment to the device.

25. The apparatus of claim 23, wherein the compartment provides a shield between the battery and the device to protect the device from battery electrolyte leakage.

26. An electronic device that obtains at least some power from a battery comprising:
a removable battery shield that protects the device from electrolyte leakage from a battery, the removable shield being one or both of disposable and reusable.

27. The electronic device of claim 26, wherein the battery shield comprises:
a nonconductive body portion enclosing at least terminals of a battery; and
electrically conductive portions that are electrically isolated from one another by the nonconductive portion, each conductive portion providing electrical connection between a terminal of the battery and the device.

28. The electronic device of claim 26, wherein the battery shield comprises a flexible membrane sheath, the sheath accommodating a battery having any commercially available battery form factor, the sheath being made of a nonconductive material and having a conductive contact through the sheath that provides an electrical connection between the battery and the device.

29. The electronic device of claim 28, wherein the membrane sheath encloses at least terminals of a battery and fits within a battery compartment of the device, the membrane sheath physically separating the battery terminals from internal electrical contacts of the compartment.

30. The electronic device of claim 29, wherein the membrane sheath fully encloses the battery to contain any electrolyte leakage.

31. The electronic device of claim 26, wherein the battery shield comprises a membrane disk, the membrane disk being made of a nonconductive material and having a conductive contact through the disk, the conductive contact providing electrical connection between a terminal of a battery and the device, the disk accommodating a battery having any commercially available battery form factor.

32. The electronic device of claim 31, wherein the membrane disk fits within a battery compartment of the device with a battery, the disk physically separating the battery terminal from an internal electrical contact of the battery compartment.

33. The electronic device of claim 26, wherein the battery shield is a tray that houses a battery, the tray being open on one side for inserting and removing the battery, the tray being made of a nonconductive material and having conductive contacts through the tray that provides an electrical connection between terminals of the battery and the device.

34. The electronic device of claim 33, wherein the tray fits within a battery compartment of the device with a battery, the tray physically separating the battery terminals from internal electrical contacts of the battery compartment.

35. The electronic device of claim 33, wherein the tray has a removable lid that fits over an inserted battery and covers the open side of the tray.

36. The electronic device of claim 26, wherein the battery shield is a battery compartment that removably attaches to the device, the battery compartment being made of a nonconductive material, the compartment comprising an interior space for housing a battery and electrically conductive contacts that electrically connect a battery inserted into the interior space of the compartment to the device.

37. The electronic device of claim 36, further comprising externally accessible electrical contacts for receiving power from a battery, the battery compartment further comprising external electrical contacts to removably connect with the externally accessible contacts of the device, the compartment physically separating the inserted battery from the device.

38. An electronic device that obtains at least some power from a battery comprising:
an electrical device contact that is accessible external to the device; and
a removable battery compartment that houses a battery and electrically connects the battery to the externally accessible device contact.

39. The electronic device of claim 38, wherein the removable battery compartment is made of a nonconductive material, the compartment comprising an interior space for housing a battery, and an external compartment contact that is electrically conductive, the external compartment contact physically connecting to the externally accessible device contact.

40. The electronic device of claim 39, wherein the compartment further comprises internal electrical contacts that are electrically isolated from one another, the internal contacts electrically connecting to different terminals of a battery inserted into the interior space, the internal electrical contacts being separately electrically connected to the external compartment contact.

41. The electronic device of claim 39, wherein one of the external compartment contact and the externally accessible device contact is a plug connector while the other is a compatible socket connector.

42. The electronic device of claim 39, wherein the removable compartment further comprises an operable lid, the interior space being accessible by opening the lid when closed, a battery being inserted into or removed from the compartment when the lid is open.

43. The electronic device of claim 38, wherein the removable compartment shields any electrolyte leakage from a housed battery from contaminating the electrical device contact.

44. The electronic device of claim 38, wherein the removable compartment is removable by a user of the device, the removable compartment being one or both of disposable and reusable, and when reusable, an interior space of the removable compartment is washable by the device user.

45. The electronic device of claim 38, wherein a battery housed in the battery compartment is one or both of removable and replaceable by a user of the device.

46. The electronic device of claim 38, further comprising a removable battery shield that protects the battery compartment from electrolyte leakage from a battery, the removable shield being one or both of disposable and reusable.

47. The electronic device of claim 46, wherein the battery shield physically separates at least the terminals of a housed battery from electrical contacts internal to the battery compartment while providing electrical connection between the terminals and the internal electrical contacts.

48. A method of protecting a battery-powered device from electrolyte leakage from a battery comprising:
inserting a battery into a battery shield, the shield physically separating at least terminals of the battery from corresponding electrical contacts in the device while providing electrical connection between the battery and the device.

49. The method of claim 48, before inserting the battery into a battery shield, further comprising:
inserting the battery shield into the device.

50. The method of claim 48, further comprising: installing the shielded battery into the device, such that the battery is electrically connected to provide power to the device.

51. The method of claim 48, wherein when the battery leaks electrolyte, the method further comprises:
removing the shielded battery from the device and removing the shield from the battery; and
cleaning the shield to remove the leaked electrolyte, such that the cleaned shield is reusable with another battery.

52. The method of claim 48, wherein when the battery leaks electrolyte, the method further comprises:
removing the shielded battery from the device; and
discarding the shield when the leaky battery is discarded.
